(19) United States
(12) Patent Application Publication
(10) Pub. No.: US 2018/0210072 A1
(43) Pub. Date: Jul. 26, 2018

(54) SCANNING LASER RADAR

(71) Applicant: HON HAI PRECISION INDUSTRY CO., LTD., New Taipei (TW)

(72) Inventor: HSIANG-CHIEH YU, New Taipei (TW)

(21) Appl. No.: 15/686,800

(22) Filed: Aug. 25, 2017

(30) Foreign Application Priority Data
Jan. 23, 2017 (TW) 106102346

(51) Int. Cl. G01S 7/481

(52) U.S. Cl. CPC G01S 7/4817

(57) ABSTRACT

A sensing laser radar includes a transmitting system and a receiving system. The transmitting system includes a laser device, a first reflector mirror, a support body configured to be vertically rotated, and a base configured to be horizontally rotated. The first reflector mirror is located on the support body, and the support body is located on the base. The receiving system includes a second reflector mirror and a photodetector.

### CROSS-REFERENCE TO RELATED APPLICATIONS

This application claims all benefits accruing under 35 U.S.C. § 119 from Taiwan Patent Application No. 106102346, filed on Jan. 23, 2017, in the Taiwan Intellectual Property Office, in the Taiwan Intellectual Property Office. Disclosures of the above-identified applications are incorporated herein by reference.

### FIELD

The present application relates to a scanning laser radar.

### BACKGROUND

Scanning laser radars can be applied to the unmanned vehicles. In order to sense moving objects such as the unmanned vehicles within a certain range, the scanning laser radar generally includes multiple laser devices and multiple photodetectors to make sure that important signals are not omitted. However, a high level of cooperation among the multiple laser devices and photodetectors is required. Otherwise, the stability of the scanning laser radar can be affected. Furthermore, the cost for making a scanning laser radar including multiple laser devices and multiple photodetectors is very high. Thus, the scanning laser radar has a relative high cost and a relative low stability.

What is needed, therefore, is to provide a scanning laser radar that can overcome the above-described shortcomings.

### BRIEF DESCRIPTION OF THE DRAWINGS

Implementations of the present technology will now be described, by way of example only, with reference to the attached figures, wherein:

FIG. 1 is a schematic view of a first exemplary embodiment of a scanning laser radar.

FIG. 2 is a schematic view of working state of an exemplary embodiment of an actuator in the scanning laser radar of FIG. 1.

FIG. 3 is a schematic view of working state of another exemplary embodiment of the actuator in the scanning laser radar of FIG. 1.

FIG. 4 is a schematic view of a second exemplary embodiment of a scanning laser radar.

FIG. 5 is a schematic view of an exemplary structure formed by a base and a support of the second exemplary embodiment.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale, and the proportions of certain parts may be exaggerated to illustrate details and features better. The description is not to be considered as limiting the scope of the embodiments described herein.

Several definitions that apply throughout this disclosure will now be presented.

The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising” means “including, but not necessarily limited to”; it specifically indicates open-ended inclusion or membership in a so-described combination, group, series and the like.

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

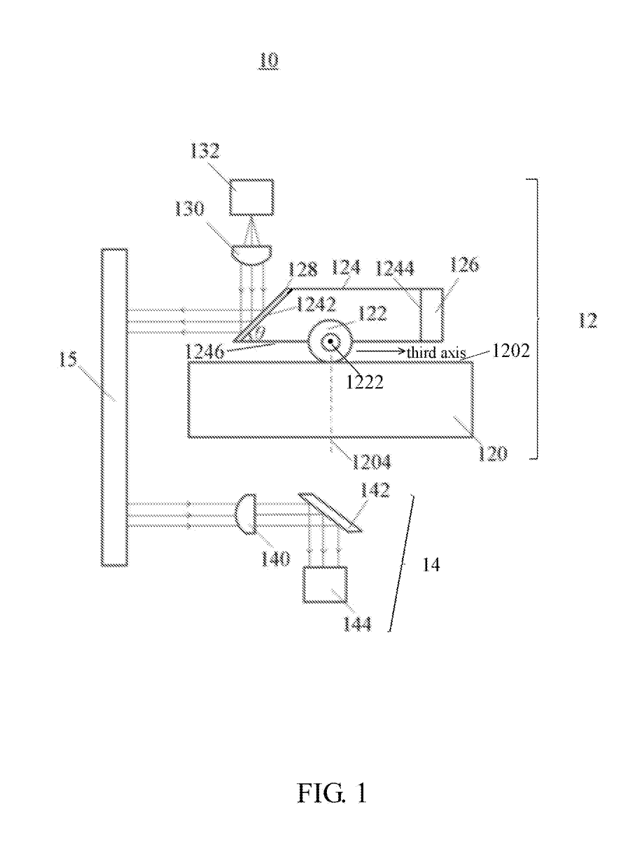

Referring to FIG. 1, a first exemplary embodiment of a sensing laser radar 10 is provided. The sensing laser radar 10 includes a transmitting system 12 and a receiving system 14. The transmitting system 12 includes a laser device 132, a first lens 130, a first reflector mirror 128, a support body 124, a roller 122, a base 120, and an actuator 126. The receiving system 14 includes a second lens 140, a second reflector mirror 142, and a photodetector 144. Each of the first lens 130 and the second lens 140 can be a collimating lens.

The base 120 has a first surface 1202 and defines a first axis 1204. The first axis 1204 is perpendicular to the first surface 1202. The base 120 can be rotated about 360 degrees around the first axis 1204 by an external force. Thus, the base 120 can be rotated horizontally. The device for generating the external force can be selected according to specific needs. The device can be an electric motor (not explicitly shown) or the like. In the first exemplary embodiment, the device for generating the external force is a brushless direct current (BLDC) motor, and the BLDC motor is electrically connected to the base 120. The material and shape of the base 120 can be selected according to specific needs. The material of the base 120 can be metal or the like. In the first exemplary embodiment, the material of the base 120 is aluminum alloy, and the base 120 is a disc-shaped.

The support body 124 and the roller 122 are located on the first surface 1202 of the base 120. The support body 124 is rotatably mounted on the roller 122, and the support body 124 can be rotated around the roller 122 in a counterclockwise or clockwise direction. The roller 122 has a planar surface (not shown), and the support body 124 is located on the planar surface, so that the support body 124 can stay on the roller 122 and hold still, when no external force is applied to the support body 124. The roller 122 may have a supporting surface (not explicitly shown) extending from each side of the roller 122 to support the support body 124. The roller 122 defines a second axis 1222. The second axis 1222 is parallel to the first surface 1202 of the base 120, and is perpendicular to the first axis 1204. In FIG. 1, the second axis 1222 is along a direction going perpendicularly in and out of the page, and shown as a dot at the center of the roller 122. In order to ensure that the support body 124 can be rotated around the second axis 1222 and the base 120 does not prevent the support body 124 from rotating, the support body 124 and the base 120 should be spaced from each other. The support body 124 has a slope 1242, a second surface 1244 opposing to the slope 1242, and a third surface 1246 having a first side and a second side opposite to the first side. The first side of the third surface 1246 is connected to the slope 1242, and second side of the third surface 1246 is connected to the second surface 1244. The third surface 1246 is the bottom surface of the support body 124. The slope 1242 and the third surface 1246 form a first angle θ, and the first angle θ can be in a range of about 0 degrees to about 90 degrees. The first angle θ can be in a range of about 30 degrees to about 60 degrees. In the first exemplary embodiment, the cross-section of the support body 124 in a direction perpendicular to the first surface 1202 is a right-angle trapezoid, the first angle θ is about 45 degrees, and the second surface 1244 is perpendicular to the third surface 1246 of the support body 124. The materials of the support body 124 and the roller 122 can be selected according to specific needs.

The actuator 126 is used to rotate the support body 124 around the roller 122 in a counterclockwise or clockwise direction. The rotation of the support body 124 is in a small range, and the angle of rotating the support body 124 can be in a range of about −45 degrees to about +45 degrees. A third axis is defined, and the third axis is horizontal and parallel to the third surface 1246, as shown in FIG. 1. The angle of counterclockwise rotation of the support body 124 can be in a range of about 0 degrees to about 45 degrees with respect to the third axis, and the angle of clockwise rotation of the support body 124 can be in a range of about 0 degrees to about 45 degrees with respect to the third axis. In the first exemplary embodiment, the angle of rotating the support body 124 is in a range of about −15 degrees to about +15 degrees. That is, the angle of counterclockwise rotation of the support body 124 can be in a range of about 0 degrees to about 15 degrees with respect to the third axis, and the angle of clockwise rotation of the support body 124 can be in a range of about 0 degrees to about 15 degrees with respect to the third axis. The type of the actuator 126 can be selected according to specific needs. The actuator 126 can includes a magnet, a coil, and an external power source for energizing the coil. According to the Lorentz force law, the motion electric charge is affected by the Lorentz force in the magnetic field, and the Ampere force is the macroscopic manifestation of the Lorentz force. Thus, when the coil is energized, the current is acted upon by the magnetic field to form a force, and the support body 124 is rotated around the roller 122 in a counterclockwise or clockwise direction by the force.

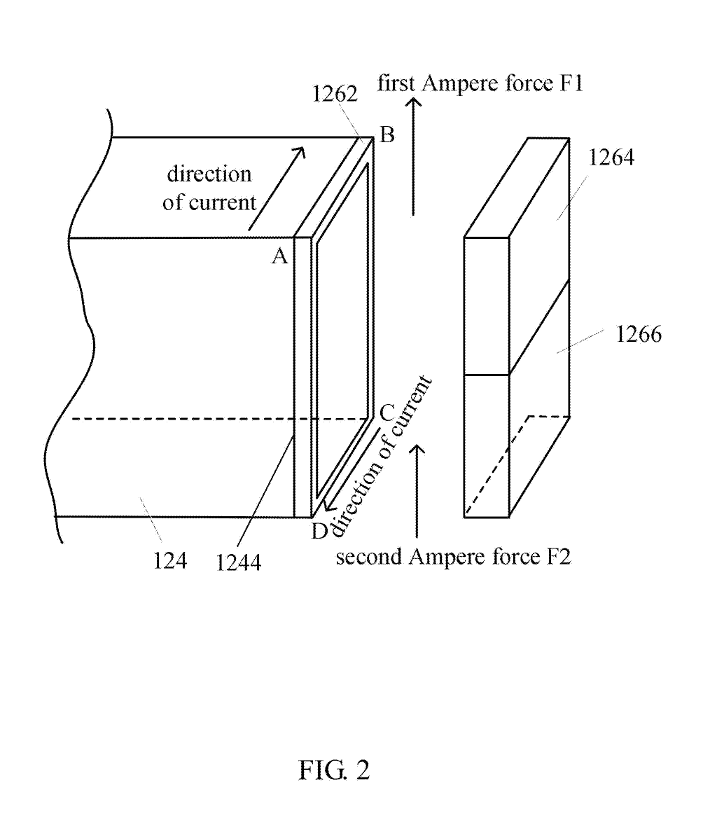

Referring to FIG. 2, the actuator 126 includes a hollow coil 1262 located on the second surface 1244 of the support body 124, a first magnet 1264, and a second magnet 1266. The first magnet 1264 and the second magnet 1266 are stacked with each other or side by side. The first magnet 1264 and the hollow coil 1262 are spaced from each other. The second magnet 1266 and the hollow coil 1262 are spaced from each other. The polarity of the first magnet 1264 is different from the polarity of the second magnet 1266. When the polarity of the first magnet 1264 is the north pole N, the polarity of the second magnet 1266 is the south pole S. When the polarity of the first magnet 1264 is the south pole S, the polarity of the second magnet 1266 is the north pole N.

The left hand rule for determining a force direction of a conductor in a magnetic field is that: stretched out the left hand, so that the five fingers and the palm are in the same plane, and the thumb is perpendicular to the other four fingers; let the magnetic induction line enter from the palm of the hand, and let the other four fingers represent the current direction; then the direction of the thumb is the force direction of the conductor in the magnetic field. In the first exemplary embodiment, the shape of the hollow coil 1262 is a rectangular, and the four sides of the rectangular are defined as AB side, BC side, CD side, and DA side. The working process of the actuator 126 is provided, as shown in FIG. 2. The polarity of the first magnet 1264 is the north pole N, the polarity of the second magnet 1266 is the south pole S, and the current is supplied to the hollow coil 1262. The current direction of the AB side is perpendicular to the BC side and from A to B; the current direction of the CD side is perpendicular to the BC side and from C to D. The AB side generates a first Ampere force F1 according to the left hand rule, and the direction of the first Ampere force F1 is from C to B. The CD side generates a second Ampere force F2 according to the left hand rule, and the direction of the second Ampere force F2 is from C to B. Thus, the support body 124 is rotated counterclockwise by the first Ampere force F1 and the second Ampere force F2. The angle of counterclockwise rotation of the support body 124 can be in a range of about 0 degrees to about 45 degrees. In the first exemplary embodiment, the angle of counterclockwise rotation of the support body 124 is in a range of about 0 degrees to about 15 degrees.

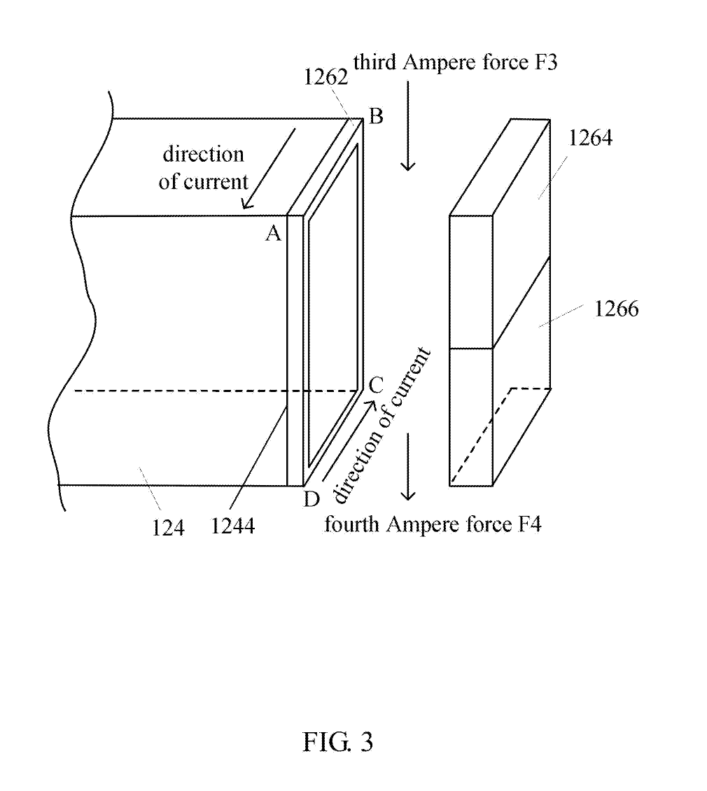

When the direction of the current is changed, the direction of the Ampere force is also changed. Referring to FIG. 3, the polarity of the first magnet 1264 is the north pole N, the polarity of the second magnet 1266 is the south pole S, and the current is supplied to the hollow coil 1262. The current direction of the AB side is perpendicular to the BC side and from B to A, the current direction of the CD side is perpendicular to the BC side and from D to C. The AB side generates a third Ampere force F3 according to the left hand rule, and the direction of the third Ampere force F3 is from B to C. The CD side generates a fourth Ampere force F4 according to the left hand rule, and the direction of the fourth Ampere force F4 is from B to C. Thus, the support body 124 is rotated clockwise by the third Ampere force F3 and the fourth Ampere force F4. The angle of clockwise rotation of the support body 124 can be in a range of about 0 degrees to about 45 degrees. In the first exemplary embodiment, the angle of clockwise rotation of the support body 124 is in a range of about 0 degrees to about 15 degrees.

Referring to FIG. 1, the first reflector mirror 128 is located on the slope 1242 of the support body 124 by a variety of ways, such as by adhesive bonding, rivet fixing, or the like. The first reflector mirror 128 is used to receive the light emitted by the laser device 132, change the propagation direction of the light, and transmit the light to a measured object 15. The first reflector mirror 128 can be a planar reflector mirror, a spherical reflector mirror, or an aspheric mirror. In the first exemplary embodiment, the first reflector mirror 128 is a planar reflector mirror.

The first lens 130 is located between the laser device 132 and the first reflector mirror 128. The first lens 130, the laser device 132, and the first reflector mirror 128 are spaced from one another. The first lens 130 is used to focus the light emitted by the laser device 132. The first lens 130 can be omitted. The first lens 130 can be located on the laser device 132.

The laser device 132 is used to emit light, and the light is focused by the first lens 130 and is transmitted to the first reflector mirror 128. The laser device 132 can be selected according to specific needs. The laser device 132 can be a carbon dioxide laser device, a YAG laser device, a neodymium-doped yttrium aluminum garnet laser device, a semiconductor laser device, or a wavelength tunable solid-state laser device.

The second lens 140 is located between the measured object 15 and the second reflector mirror 142. The second lens 140, the measured object 15, and the second reflector mirror 142 are spaced from each other. The second lens 140 is used to focus the light reflected from the measured object 15.

The second reflector mirror 142 is located on the light path from the second lens 140 to the photodetector 144. The second reflector mirror 142 is used to receive the light reflected from the measured object 15, change the propagation direction of the light, and transmit the light to the photodetector 144. The second reflector mirror 142 can be the planar reflector mirror, the spherical reflector mirror, or the aspheric mirror. In the first exemplary embodiment, the second reflector mirror 142 is the planar reflector mirror.

The photodetector 144 is used to sense the light reflected by the second reflector mirror 142. The type of the photodetector 144 can be selected according to specific needs. The photodetector 144 can be a photomultiplier tube, a semiconductor photodiode, an avalanche photodiode, a multivariate infrared detector, or a visible light multiplex detector.

The sensing laser radar 10 further includes an information processing system (not shown). The information processing system is a computer-based processing system which processes and analyzes the information obtained by the photodetector 144.

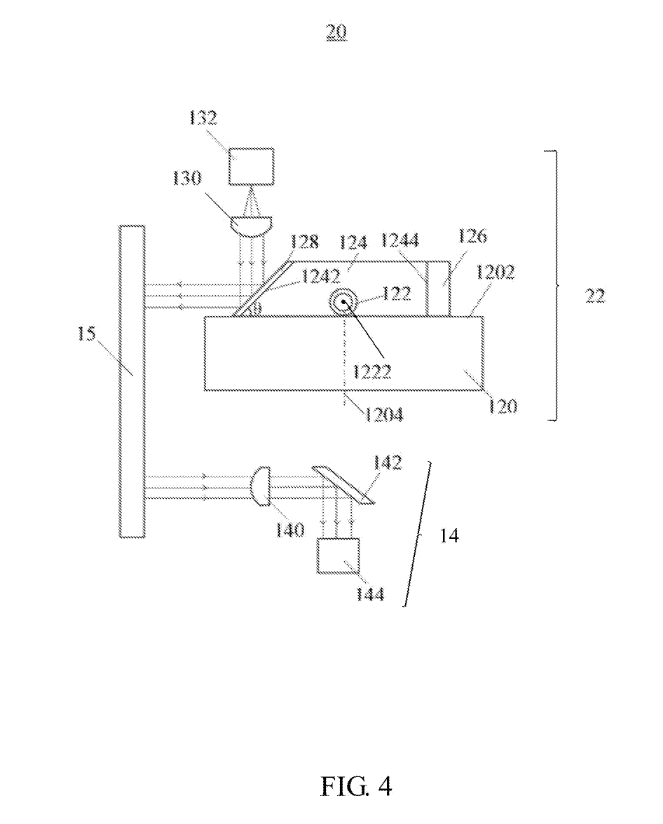

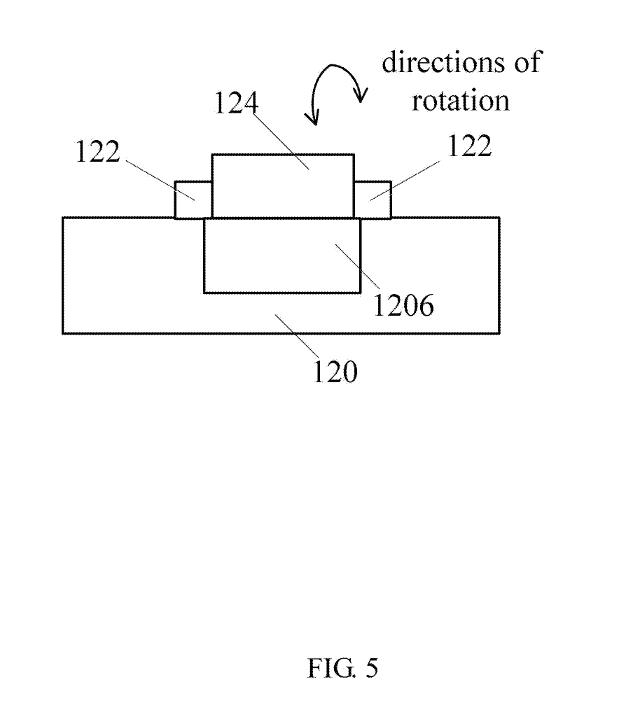

Referring to FIG. 4, a second exemplary embodiment of the sensing laser radar 20 is provided. The sensing laser radar 20 includes a second transmitting system 22 and a receiving system 14. The second transmitting system 22 includes a laser device 132, a first lens 130, a first reflector mirror 128, a support body 124, a roller 122, a base 120, and a actuator 126. The receiving system 14 includes a second lens 140, a second reflector mirror 142, and a photodetector 144. The sensing laser radar 20 of the second exemplary embodiment is similar to the sensing laser radar 10 of the first exemplary embodiment above except the positional relationship between the support body 124 and the base 120. In the sensing laser radar 20, the support body 124 is located on the base 120 by two rollers 122, as shown in FIG. 5.

Referring to FIG. 5, in the second exemplary embodiment, the base 120 has a groove 1206 having a width greater than or equal to the width of the support body 124. The depth of the groove 1206 is greater than or equal to the height of the support body 124. When the support body 124 is rotated around the roller 122, the support body 124 can be embedded into the groove 1206, so that the base 120 does not prevent the support body 124 from rotating. The groove 1206 can be designed as a through hole or a blind hole, as long as the base 120 does not prevent the support body 124 from rotating in counterclockwise or clockwise direction. In the second exemplary embodiment, the support body 124 can be in direct contact with the base 120, because the groove 1206 in the base 120 can accommodate the support body 124 when the support body 124 is rotated.

The sensing laser radar 10 includes only one laser device 132 and only one photodetector 144. The first reflector mirror 128 is rotated up and down by driving of the actuator 126 to vertically scan in a small range. The first reflector mirror 128 is horizontally rotated by the motor to horizontally scan in 360 degrees range. Thus, the sensing laser radar 10 can three-dimensional scan 360 degrees. Compared with the conventional scanning laser radars, the numbers of the laser device 132 and the photodetector 144 in the sensing laser radar 10 are greatly reduced, so that the sensing laser radar 10 has a reduced cost and improved stability.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

Additionally, it is also to be understood that the above description and the claims drawn to a method may include some indication in reference to certain steps. However, the indication used is only to be viewed for identification purposes and not as a suggestion as to an order for the steps.

What is claimed is:

1. A sensing laser radar comprising:
a transmitting system comprising a laser device, a first reflector mirror, a support body configured to be vertically rotated, and a base configured to be horizontally rotated, wherein the first reflector mirror is located on the support body, and the support body is located on the base; and
a receiving system comprising a second reflector mirror and a photodetector.

2. The sensing laser radar of claim 1, wherein the base has a first surface and defines a first axis perpendicular to the first surface, a roller is located on the first surface, the support body is located on the roller, the roller defines a second axis parallel to the first surface and perpendicular to the first axis, and the transmitting system further comprises an actuator that is used to rotate the support body around the roller in a counterclockwise or clockwise direction.

3. The sensing laser radar of claim 2, wherein an angle of counterclockwise rotation of the support body is in a range of about 0 degrees to about 45 degrees.

4. The sensing laser radar of claim 2, wherein an angle of clockwise rotation of the support body is in a range of about 0 degrees to about −45 degrees.

5. The sensing laser radar of claim 2, wherein the actuator comprises a hollow coil located on the support body, a first magnet, and a second magnet; the first magnet and the second magnet are adjacent to each other, the first magnet and the hollow coil are spaced from each other, and the second magnet and the hollow coil are spaced from each other; and a first polarity of the first magnet is different from a second polarity of the second magnet.

6. The sensing laser radar of claim 5, wherein the support body has a slope and a second surface opposing the slope, the first reflector mirror is located on the slope, and the hollow coil is located on the second surface.

7. The sensing laser radar of claim 1, wherein the base has a groove having a first width greater than or equal to a second width of the support body, and a depth of the groove is greater than or equal to a height of the support body.

8. The sensing laser radar of claim 1, wherein the transmitting system further comprises a first lens located between the laser device and the first reflector mirror; and the first lens, the laser device, and the first reflector mirror are spaced from one another.

9. The sensing laser radar of claim 1, wherein the receiving system further comprises a second lens, and the second reflector mirror is located on a light path from the second lens to the photodetector.

10. The sensing laser radar of claim 1, wherein the number of the laser device is one, and the number of the photodetector is one.

11. The sensing laser radar of claim 1, wherein the first reflector mirror and the second reflector mirror are planar reflector mirrors.

12. The sensing laser radar of claim 1, wherein the base has a through hole, and the support body is embedded in the through hole when the support body is rotated around the roller.
